(19) United States
(12) Patent Application Publication
(10) Pub. No.: US 2019/0054602 A1
(43) Pub. Date: Feb. 21, 2019

(54) FASTENER HOLDER TOOL AND METHOD

(71) Applicant: Honda Motor Co., Ltd., Tokyo (JP)

(72) Inventor: Jared Daniel Sebree, Hilliard, OH (US)

(21) Appl. No.: 15/677,067

(22) Filed: Aug. 15, 2017

(51) Int. Cl. B25B 23/10; B25B 23/00

(52) U.S. Cl. CPC B25B 23/108; B25B 21/00; B25B 23/0035

(57) ABSTRACT

A fastener holder tool and method includes a fastener shaft having a fastener shaft distal end configured for complementary engagement with a fastener and first and second collars slidably mounted on the fastener shaft. The first collar has a base portion annularly disposed about the fastener shaft and a plurality of teeth arms extending from the base portion in a direction toward the fastener shaft distal end for resiliently holding the associated fastener. The second collar has a body portion annularly disposed about the fastener shaft and radially interposed between the fastener shaft and the plurality of teeth arms of the first collar. The fastener holder tool further includes a cam engagement between the first collar and the second collar that moves the plurality of teeth arms radially outwardly for releasing the associated fastener as the associated fastener is fully installed into an associated workpiece.

### BACKGROUND

Vehicle assembly requires many fasteners (e.g., screws, bolts and the like) to be applied and installed. Some of these fasteners are manually installed by an assembly line worker (e.g., using a manual or powered torque fastener installation tool). On some processes, one-handed operation of the fastener installation tool is required. This is a particular difficulty where no holding mechanism is associated with the fastener tool for holding the fastener thereby requiring the operator to use one hand to hold the fastener in place and use the other hand to operate the fastener tool for installing the fastener.

It is known to use a fastener tool having a magnetic bit for holding the fastener in place. This sometimes enables the operator to use only a single hand on the fastener tool. However, there are many non-magnetic fasteners applied to vehicles that preclude the use of a magnetic fastener tool (e.g., stainless steel fasteners). These again require the operator to use one hand to hold the fastener, such as to keep it tight against the fastener tool while operating the tool, and use the other hand for manipulating the fastener tool. An additional concern when applied fasteners to vehicles is possible marring of the vehicle, particular any show surface, by the fastener tool.

### BRIEF DESCRIPTIONS

According to one aspect, a fastener holder tool includes a fastener shaft having a fastener shaft distal end configured for complementary engagement with an associated fastener, a first collar slidably mounted on the fastener shaft, and a second collar slidably mounted on the fastener shaft. The first collar has a base portion annularly disposed about the fastener shaft and a plurality of teeth arms extending from the base portion in a direction toward the fastener shaft distal end for resiliently holding the associated fastener. The second collar has a body portion annularly disposed about the fastener shaft and radially interposed between the fastener shaft and the plurality of teeth arms of the first collar. The fastener holder tool further includes a cam engagement between the first collar and the second collar that moves the plurality of teeth arms radially outwardly for releasing the associated fastener as the associated fastener is fully installed into an associated workpiece.

According to another aspect, a fastener installation method includes inserting a fastener axially into a plurality of teeth arms of a first collar slidably mounted on a fastener shaft for temporarily securing the fastener relative to the first collar and the fastener shaft. The plurality of teeth arms extend from a base portion of the first collar annularly disposed about the fastener shaft. The method further includes complementarily engaging a distal end of the fastener shaft with the fastener for translating rotation of the fastener shaft into rotation of the fastener; rotating the fastener shaft to thereby rotate the fastener and install the fastener into a workpiece; and forcing the plurality of teeth arms to flex radially outwardly via a camming action to reduce a gripping force on the fastener as the fastener approaches full installation into the workpiece. The camming action is due to a cam engagement between the first collar and the second collar slidably mounted on the fastener shaft. The second collar has a body portion annularly disposed about the fastener shaft and radially interposed between the fastener shaft and the plurality of teeth arms of the first collar.

According to a further aspect, a fastener holder tool for installing a fastener into a vehicle includes a fastener shaft having a fastener shaft distal end with a complementary fastener engagement shape, a first collar, and a second collar. The first collar is slidably mounted on the fastener shaft and has a plurality of axially extending teeth arms for resiliently holding the fastener. Each of the plurality of axially extending teeth arms has a first collar tapered surface on an inward radial side thereof. The second collar is slidably mounted on the fastener shaft and has a body portion annularly disposed about the fastener shaft and radially interposed between the fastener shaft and the plurality of teeth arms on the first collar. The body portion has a second collar tapered surface on an outward radial side thereof that engages the first collared tapered surface during installation of the fastener and moves the first collar relative to the fastener shaft and radially flexes the plurality of axially extending teeth arms radially outwardly to reduce a holding force on the fastener.

### BRIEF DESCRIPTION OF THE DRAWINGS

FIG. 1 is a perspective view showing a fastener holder tool according to an exemplary embodiment and the associated fastener to be installed via the fastener holder tool.

FIG. 2 is an exploded perspective view of first and second collars of the fastener holder tool of FIG. 1.

FIG. 3 is a schematic cross-sectional view of the fastener holder tool of FIG.

FIG. 4 is an elevational view of the fastener holder tool of FIG. 1 showing a proximal end thereof.

FIG. 5 is an elevational view of a fastener holder tool according to an alternate exemplary embodiment wherein a proximal end thereof has an alternate configuration.

FIG. 6 is a schematic cross-sectional view showing the fastener holder tool of FIG. 1 holding the fastener of FIG. 1 just prior to installation of the fastener into a workpiece.

FIG. 7 is a cross-sectional view similar to FIG. 6 but showing the fastener being inserted into the workpiece.

FIG. 8 is a cross-sectional view similar to FIGS. 6 and 7 but showing the fastener when nearly fully installed into the workpiece.

FIG. 9 is a schematic cross-sectional view similar to FIGS. 6-8 but showing the fastener fully installed into the workpiece.

### DETAILED DESCRIPTION

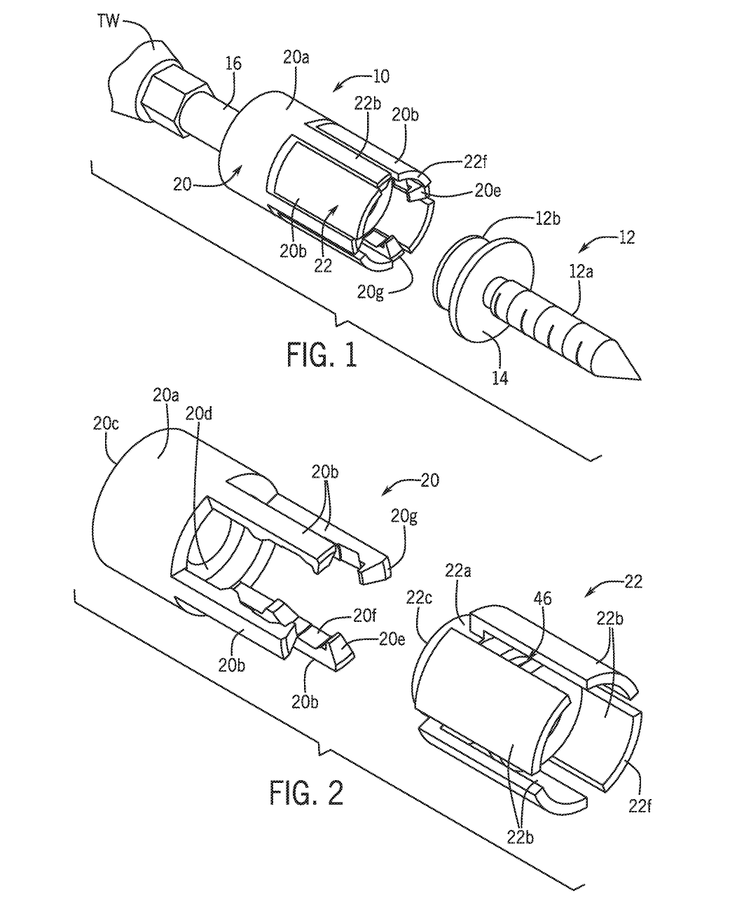

Referring now to the drawings wherein the showings are for purposes of illustrating one or more exemplary embodiments and not for purposes of limiting the same, FIG. 1 shows a fastener holder tool 10 according to an exemplary embodiment and an associated fastener 12 that can be installed via the fastener holder tool 10. In one embodiment, the fastener 12 is a threaded fastener, such as a screw, having a threaded shaft portion 12a and a head portion 12b and is used together with, and thus includes, a washer 14. In one application, the tool 10 can be used for installing the fastener 12 into a vehicle. For example, the tool 10 can be used in conjunction with a rotating device (e.g., a powered torque wrench, only a portion TW of which is shown in FIG. 1).

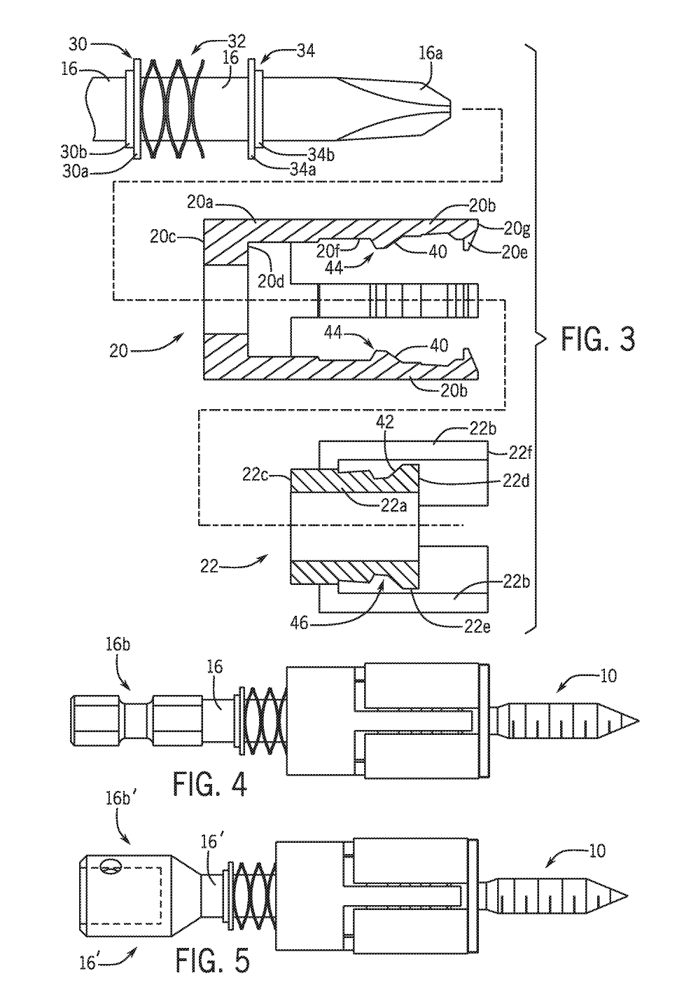

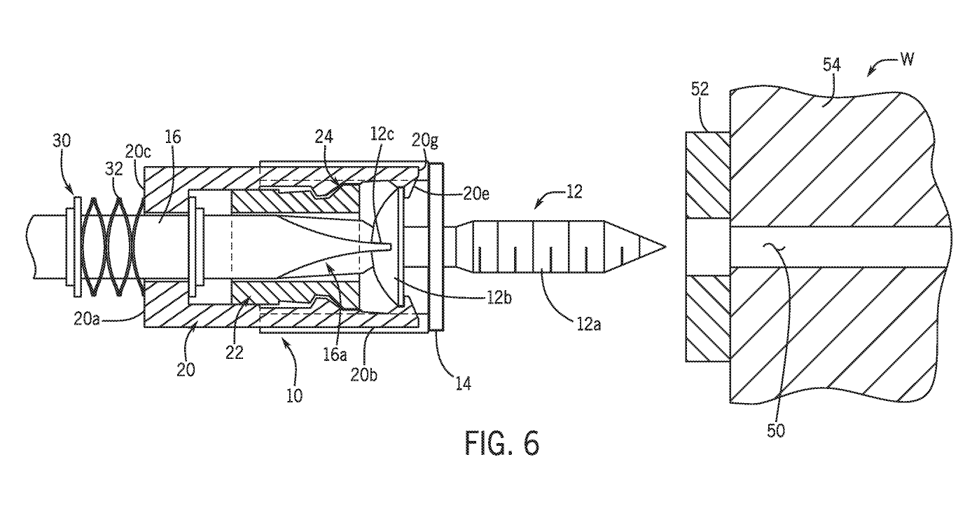

With additional reference to FIGS. 2 and 3, the tool 10 includes a fastener shaft 16 having a fastener shaft distal end 16a configured for complementary engagement with the fastener 12. Thus, the distal end 16a can be formed or provided with a complementary fastener engagement shape. For example, the fastener shaft distal end 16a can have a Phillips configuration for complementarily mating via complementary engagement with a corresponding Phillips configuration 12c on the head portion 12b of the fastener 12 (see FIGS. 6-9). Of course, it should be understood and appreciated that other drive configurations can be used for the complementary engagement between the fastener shaft 16 and the fastener 12 and all such alternative configurations for transferring torque from the fastener shaft 16 to the fastener 12 are to be considered within the scope of the present disclosure.

As used herein, the terms distal, distally and the like are used for reference on the tool 10 for elements located farther away from an end (e.g., proximal end 16b or 16b′ shown respectively in FIGS. 4 and 5) of the tool 10 more adjacent an operator's hand and located closer to the end 16a that engages the fastener 12. Likewise, the terms proximal, proximally and the like are used for reference on the tool 10 for elements located closer to the end (e.g., proximal end 16b or 16b′) of the tool 10 more adjacent the operator's hand and located farther away from the end 16a that engages the fastener 12.

As shown in FIGS. 1-3, the tool 10 further includes a first collar 20 and a second collar 22. The first collar 20 is slidably mounted on the fastener shaft 16. The first collar 20 has a base portion 20a annularly disposed about the fastener shaft 16 and a plurality of axially extending teeth arms 20b extending from the base portion 20a in a direction (e.g., a first direction) toward the fastener shaft distal end 16a (to the right in FIGS. 1-3) for resiliently holding the fastener 12. The first collar 20 further includes a proximal end 20c of the base portion 20a (and of the first collar 20) and a distal end 20d of the base portion 20a. Additionally, the first collar 20 includes fastener retention projections 20e disposed on an inward radial side 22f of each of the plurality of teeth arms 20b for retaining the fastener 12. The fastener retention projections 20e are axially located at or adjacent distal ends 20g of the plurality of teeth arms with the distal ends 20g also forming a distal end of the first collar. The fastener retention projections 20e can be configured and/or sized so as to grip below the head portion 12b of the fastener 12. As will also be described in more detail below, the projections 20e function to retain the fastener 12 and a cam engagement 24 (FIGS. 6-9) between the first collar 20 and the second collar 22 moves the plurality of teeth arms 20b radially outwardly for releasing the fastener 12 as the fastener 12 is fully installed into an associated workpiece W (see FIGS. 6-9).

The second collar 22 is likewise slidably mounted on the fastener shaft 16. The second collar 22 has a body portion 22a annularly disposed about the fastener shaft 16 and radially interposed between the fastener shaft 16 and the plurality of teeth arms 20b of the first collar 20. The second collar 22 also has a plurality of grip arms 22b extending from the body portion 22a in said direction toward the fastener shaft distal end 16a of the fastener shaft 16 (i.e., to the right in FIGS. 1-3). Each of the plurality of grip arms 22b is circumferentially interposed between adjacent ones of the plurality of teeth arms 20b of the first collar 20. The second collar 22 further includes a proximal end 22c of the body portion 22a (and the second collar 22) and a distal end 22d of the body portion 22a with an outward radial side 22e extending from the proximal end 22c to the distal end 22d. The grip arms 22b are connected to the body portion 22a at a location between the proximal and distal ends 22c, 22d. The grip arms 22b have respective distal ends 22f for engagement with the fastener 12, and particularly for engagement with the washer 14 of the fastener 12.

The tool 10 additionally includes a proximal stop member or stop 30 disposed on the fastener shaft in an axially fixed position for limiting axial travel of the first collar 20 relative to the fastener shaft 16 in a direction (e.g., a second direction) away from the fastener shaft distal end 16a (to the left in FIGS. 1-3). A spring 32 is annularly disposed on the fastener shaft 16 axially between the proximal stop member 30 and the proximal end 20c of the first collar 20. The spring urges the first collar 20 in the first direction toward the fastener shaft distal end 16a. In one embodiment, the proximal stop member 30 is formed by a washer 30a and a retaining ring 30b. In the same or another embodiment, the spring 32 is formed as a stacked wave disc spring.

The tool 10 further includes a distal stop member or stop 34 disposed on the fastener shaft 16 in an axially fixed position for limiting axial travel of both the first collar 20 and the second collar 22. In particular, the distal stop member 34 is axially interposed between the distal end 20d of the base portion 20a and a proximal end 22c of the second collar 22. In one embodiment, the distal stop member 34 is formed by a washer 34a and a retaining ring 34b. By this arrangement, and as will be described in more detail below, the spring 32 urges the head portion 12b of the fastener 12 into complementary engagement with the fastener shaft distal end 16a of the fastener shaft 16. More particularly, the spring 32 urges the first collar 20 in the second direction away from the distal end 16b and the fastener retention projections 20e urge the fastener in the second direction by gripping an underside of the head portion 12b of the fastener 12.

With further reference to FIGS. 6-9, the cam engagement 24 includes a first collar tapered surface 40 disposed on each of the plurality of teeth arms 20b and a second collar tapered surface 42 disposed on the body portion 22a of the second collar 22. More particularly, in the illustrated embodiment, each of the plurality of teeth arms 20b of the first collar 20 includes a radial protuberance 44 received in (at least initially) a circumferential groove 46 defined in the body portion 22a of the second collar 22. The radial protuberance 44 of each of the plurality of teeth arms 20b extends from the inward radial side 20f of each of the teeth arms 20b and defines the first collar tapered surface 40 on a distal side thereof (i.e., on a distal side of the radial protuberance 44). The second collar tapered surface 42 is defined in the outward radial side 22e of the second collar 22 and defines a distal side of the circumferential groove 46. Receipt of the radial protuberance 44 within the circumferential groove 46 maintains relative positioning between the first collar 20 and the second collar 22, at least during initial installation of the fastener 12 (i.e., until the second collar 22 engages the washer 14 and the washer 14 engages the first workpiece 52). As will be described further below, engagement of the second collar 22 with the washer 14 and engagement of the washer 14 with the workpiece 52 axially moves the second collar 22 relative to the first collar 20 such that the tapered surfaces 40, 42 of the first and second collars 20, 22 interact to forcibly move the plurality of teeth arms 20b radially outwardly.

Thus, each of the plurality of teeth arms 20b has the first collar tapered surface 40 provided on an inward radial side 20f of each of the plurality of teeth arms 20b. Complementarily, the second collar tapered surface 42 is provided on an outward radial side 22e of the second collar 22 and is provided so as to engage the first collar tapered surface 40 during installation of the fastener 12 and moves the first collar 20 relative to the fastener shaft 16 and radially flexes the plurality of teeth arms 20b radially outwardly to reduce a holding force on the fastener 12 when the fastener 12 is near full installation into a workpiece (e.g., workpiece W of FIGS. 6-9).

FIG. 4 illustrates a proximal end 16b of the fastener shaft 16 and of the fastener holder tool 10 according to one embodiment. In this embodiment, the proximal end 16b is configured as a hex bit and can be installed into another associated tool (not shown) for applying rotation to the fastener shaft 16. With reference to FIG. 5, a fastener tool 16′ having a proximal end 16b′ is shown as an alternate embodiment wherein the proximal end 16b′ is configured as a socket bit. In all other respects, the tool 16′ can be the same or similar to the tool 16. It is to be understood and appreciated by those skilled in the art that other configurations for the proximal end (not shown) could be provided. In one embodiment, the end 16b or 16b′ is removably secured to a powered torque tool to be held by an operator to apply powered rotation to the tool 10.

With specific reference now to FIGS. 6-9, a fastener installation method will be described according to an exemplary embodiment. In particular, the method will be described in association with the fastener holder tool 10 described hereinabove, though it is to be understood and appreciated that method could be used with other fastener tools. As shown in FIG. 6, the fastener 12 is first inserted axially into the plurality of teeth arms 20b of the first collar 20 for temporarily securing the fastener 12 relative to the first collar 20 and the fastener shaft 16. As already described herein, the plurality of teeth arms of 20b extend from the base portion 20a of the first collar, which is annularly disposed about, and slidably mounted on, the fastener shaft 16. Specifically, the head portion 12b of the fastener 12 is axially inserted into the first collar 20 so that the projections 20e move axially past the head portion 12b and grip an underside of the head portion 12b. This insertion of the fastener 12 will cause brief outward radial flexing of the teeth arms 20b, which are resiliently formed to permit such flexing.

The method also includes complementarily engaging the distal end 16a of the fastener shaft 16 with the fastener 12 for translating rotation of the fastener shaft 16 in the rotation of the fastener 12. In the illustrated embodiment, the head portion 12b of the fastener 12 has a Phillips configuration 12c that is complementary to the distal end 16a of the fastener shaft 16. As the fastener 12 is axially inserted into the first collar 20, the fastener 12 can be rotated to align the distal end 16a with the configuration 12c provided in the head portion 12b. In particular, the head portion 12b of the fastener 12 is snapped axially into position so as to be radially captured by the plurality of teeth arms 20b. The fastener retainer projections 20e grip below the head portion 12b of the fastener 12. The spring 32 acting between the proximal stop member 30 and the proximal end 20c of the first collar 20 applies, via the fastener retention projections 20e, a pulling or gripping force against the underside of the head portion 12b of the fastener 12 to maintain complementary engagement between the fastener 12 and the distal end 16a of the fastener shaft 16 as shown in FIG. 6.

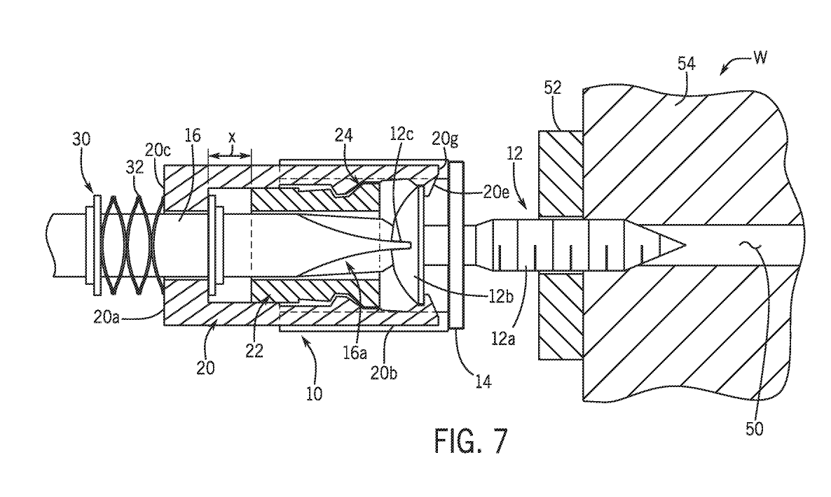

As shown in FIG. 7, the fastener 12 can be inserted into aperture 50 in the workpiece W. In particular, the workpiece W can include first workpiece 52 and second workpiece 54 with at least second workpiece 54 being configured with threads such that fastener 12 can threadedly engage the second workpiece 54 as the fastener 12 is installed in the workpiece W for securing the first workpiece 52 to the second workpiece 54. This step can include rotating the fastener shaft 16 to thereby rotate the fastener 12 and install the fastener 12 into the workpiece W.

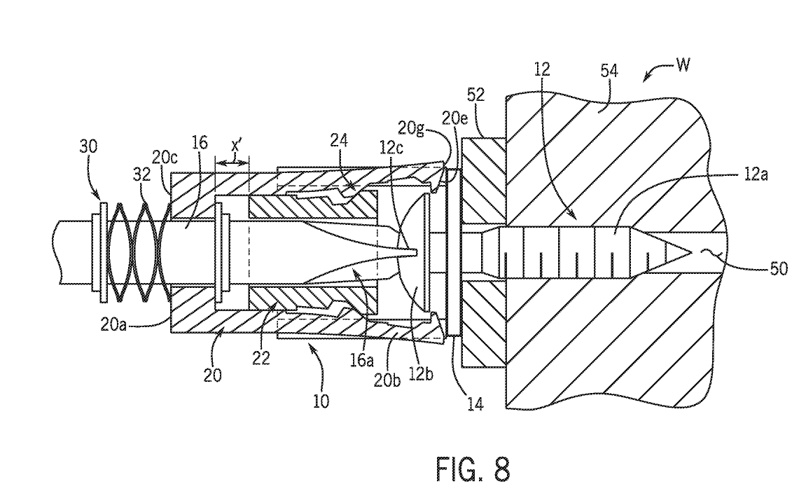

With reference now to FIG. 8, as the fastener 12 approaches full installation into the workpiece W, the distal ends 22f of the grip arms 22b of the second collar 22 continue to engage the washer 14 and the washer 14 engages the workpiece 52 preventing further axially movement of the washer 14 relative to the workpiece 52. This then causes the second collar 22 to slide axially relative to the first collar 20. Such relative movement causes the cam engagement 24 between the tapered surfaces 40, 42 to effect outward radial flexing of the plurality of teeth arms 20b as shown in FIG. 8. Notably, the distal ends 20g of the first collar remain spaced apart from the washer 14 (and also the workpiece 52) during the entire installation process.

Thus, the method includes forcing the plurality of teeth arms to flex radially outwardly via a camming action (i.e., via the cam engagement 24) to reduce a gripping force onto fastener 12 as the fastener 12 approaches full installation into the workpiece W. The camming action is due to the cam engagement 24 between the first collar 20 and the second collar 22 as already described herein. Accordingly, the distal stop member 34 limits axial movement of the second collar 22 relative to the fastener shaft 16 such that the second collar tapered surface 42 axially moves relative to the first collar tapered surface 40 to radially flex the plurality of teeth arms 20b radially outwardly.

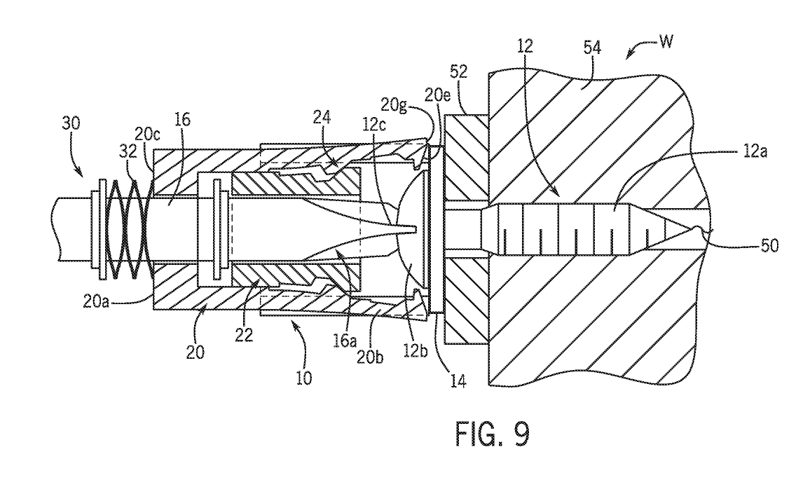

Finally, with reference to FIG. 9, the fastener 12 is shown fully installed into the workpiece W. With the plurality of teeth arms 20b fully radially flexed out, the fastener retention projections 20e are radially positioned relative to the head portion 12b of the fastener 12 so that the tool 10 can be easily pulled away from the fastener 12 and thus the workpiece W. Advantageously, the plurality of teeth arms 20b never need to engage the workpiece W (or the washer 14), particularly the first workpiece 52 disposed outward relative to the second workpiece 54, during installation of the fastener 12 so there is no impact to any appearance defining parts, such as when the workpiece W is on a vehicle. Also advantageous is the spring 32 urging full engagement between the distal end 16a of the fastener shaft 16 and the fastener 12 during the entire installation process of the fastener 12 into the workpiece W.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A fastener holder tool, comprising:
a fastener shaft having a fastener shaft distal end configured for complementary engagement with an associated fastener;
a first collar slidably mounted on the fastener shaft, the first collar having a base portion annularly disposed about the fastener shaft and a plurality of teeth arms extending from the base portion in a direction toward the fastener shaft distal end for resiliently holding the associated fastener;
a second collar slidably mounted on the fastener shaft, the second collar having a body portion annularly disposed about the fastener shaft and radially interposed between the fastener shaft and the plurality of teeth arms of the first collar; and
a cam engagement between the first collar and the second collar that moves the plurality of teeth arms radially outwardly for releasing the associated fastener as the associated fastener is fully installed into an associated workpiece.

2. The fastener holder tool of claim 1 wherein the cam engagement includes a first collar tapered surface disposed on each of the plurality of teeth arms and a second collar tapered surface disposed on the body portion of the second collar.

3. The fastener holder tool of claim 2 further including a stop member annularly disposed on the fastener shaft to limit axial movement of the first collar relative to the fastener shaft.

4. The fastener holder tool of claim 3 wherein the stop member is a distal stop member and the fastener holder tool further includes a proximal stop member, and wherein the base portion of the first collar is axially interposed between the distal and proximal stop members.

5. The fastener holder tool of claim 4 further including a spring annularly disposed on the fastener shaft and axially disposed between the proximal stop member and the base portion of the first collar.

6. The fastener holder tool of claim 5 wherein the spring is a stacked wave disk spring.

7. The fastener holder of claim 5 wherein each of the plurality of teeth arms include a fastener retention projection extending radially inwardly for retaining the associated fastener.

8. The fastener holder tool of claim 1 wherein the second collar has a plurality of grip arms extending from the body portion in said direction toward the fastener shaft distal end, each of said plurality of grip arms circumferentially interposed between adjacent ones of the plurality of teeth arms of the first collar.

9. The fastener holder tool of claim 1 further including a proximal stop member disposed on the fastener shaft in an axially fixed position for limiting axial travel of the first collar in a second direction away from the fastener shaft distal end.

10. The fastener holder tool of claim 9 further including a spring annularly disposed on the fastener shaft axially between the proximal stop member and a proximal end of the first collar, the spring urging the first collar in the direction toward the fastener shaft distal end.

11. The fastener holder of claim 10 further including a distal stop member disposed on the fastener shaft in an axially fixed position for limiting axial travel of the first collar and the second collar.

12. A fastener installation method, comprising:
inserting a fastener axially into a plurality of teeth arms of a first collar slidably mounted on a fastener shaft for temporarily securing the fastener relative to the first collar and the fastener shaft, the plurality of teeth arms extending from a base portion of the first collar annularly disposed about the fastener shaft;
complementarily engaging a distal end of the fastener shaft with the fastener for translating rotation of the fastener shaft into rotation of the fastener;
rotating the fastener shaft to thereby rotate the fastener and install the fastener into a workpiece; and
forcing the plurality of teeth arms to flex radially outwardly via a camming action to reduce a gripping force on the fastener as the fastener approaches full installation into the workpiece, said camming action due to a cam engagement between the first collar and a second collar slidably mounted on the fastener shaft, the second collar having a body portion annularly disposed about the fastener shaft and radially interposed between the fastener shaft and the plurality of teeth arms of the first collar.

13. The fastener installation method of claim 12 wherein the cam engagement includes a first collar tapered surface disposed on each of the plurality of teeth arms and a second collar tapered surface disposed on the body portion of the second collar.

14. The fastener installation method of claim 13 further including:
limiting axial movement of the second collar relative to the fastener shaft such that the second collar tapered surface axially moves relative to the first collar tapered surface to radially flex the plurality of teeth arms radially outwardly.

15. The fastener installation method of claim 12 further including
urging a fastener shaft distal end of the fastener shaft into complementary engagement with the fastener.

16. The fastener installation method of claim 12 further including:
resiliently urging distal ends of the plurality of teeth arms radially inwardly into a head portion of the fastener for gripping the fastener.

17. A fastener holder tool for installing a fastener into a vehicle, comprising:
a fastener shaft having a fastener shaft distal end with a complementary fastener engagement shape;
a first collar slidably mounted on the fastener shaft and having a plurality of axially extending teeth arms for resiliently holding the fastener, each of the plurality of axially extending teeth arms having a first collar tapered surface on an inward radial side thereof; and
a second collar slidably mounted on the fastener shaft and having a body portion annularly disposed about the fastener shaft and radially interposed between the fastener shaft and the plurality of teeth arms of the first collar, the body portion having a second collar tapered surface on an outward radial side thereof that engages the first collar tapered surface during installation of the fastener and moves the first collar relative to the fastener shaft and radially flexes the plurality of axially extending teeth arms radially outwardly to reduce a holding force on the fastener.

18. The fastener holder tool of claim 17 further including:
a spring urging a head portion of the fastener into complementary engagement with the fastener shaft distal end of the fastener shaft.

19. The fastener holder tool of claim 18 further including:
a proximal stop axially fixed on the fastener shaft;
a distal stop axially fixed on the fastener shaft, wherein the first collar includes a base portion axially interposed between the proximal and distal stops, and further wherein the spring is axially interposed between the proximal stop and the base portion of the first collar.

20. The fastener holder tool of claim 17 wherein each of the plurality of teeth arms of the first collar includes a radial protuberance received in a circumferential groove defined in the body portion of the second collar, the radial protuberance defining the first collar tapered surface on a distal side thereof and the second collar tapered surface defining a distal side of the circumferential groove.
